(19) United States
(12) Patent Application Publication
(10) Pub. No.: US 2018/0032226 A1
(43) Pub. Date: Feb. 1, 2018

(54) MOBILE TERMINAL AND CONTROL METHOD THEREFOR

(71) Applicant: LG ELECTRONICS INC., Seoul (KR)

(72) Inventors: Sangyeol RYU, Seoul (KR); Hyomoon CHO, Seoul (KR); Yongsang TAK, Seoul (KR); Chansu PARK, Seoul (KR)

(73) Assignee: LG ELECTRONICS INC., Seoul (KR)

(21) Appl. No.: 15/550,631

(22) PCT Filed: Nov. 4, 2015
(86) PCT No.: PCT/KR2015/011800

§ 371 Date: Aug. 11, 2017

(30) Foreign Application Priority Data
Feb. 11, 2015 (KR) 10-2015-0020661

(51) Int. Cl. G06F 3/0488; G06F 3/0481; H04N 5/232; G06F 3/0482

(52) U.S. Cl. CPC G06F 3/0488; G06F 3/0482; G06F 3/04817; H04N 5/23293; H04N 5/23216; H04N 5/247

(57) ABSTRACT

The present invention relates to a mobile terminal that can output certain information in response to a touch input received when the mobile terminal is in an idle state, and a control method therefor. A mobile terminal in this regard may comprise: a sensing unit for sensing a tilt of the mobile terminal; a display unit for outputting information; and a control unit for controlling and outputting a list of applications that have been recently executed in response to a touch input when the touch input is received through the display unit, wherein the control unit controls so as to output a first application list of applications that have been executed in a landscape mode if the touch input is received when the mobile terminal is laid horizontally, and controls so as to output a second application list of applications that have been executed in a portrait mode if the touch input is received when the mobile terminal is laid vertically.

### TECHNICAL FIELD

The present invention relates to a mobile terminal capable of outputting prescribed information in response to a touch input received when the mobile terminal is in an idle state and a method of controlling therefor.

### BACKGROUND ART

Generally, terminals can be classified into mobile/portable terminals and stationary terminals according to a presence or non-presence of mobility. And, the mobile terminals can be further classified into handheld terminals and vehicle mounted terminals according to availability for hand-carry.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As the functions of the terminals are diversified, for example, the terminals are implemented in a form of a multimedia player equipped with complex functions such as capturing pictures or videos, playing music and video files, gaming, receiving broadcasting, and the like.

As functions of mobile terminals are diversified, various data can be handled by the mobile terminals. As a result, the importance of security of the mobile terminals is also increasing. As an example, in order to protect the privacy of a mobile terminal, it may set a password to the mobile terminal. The mobile terminal to which the password is set can make a user not to access data until the lock of the mobile terminal is cancelled via the password.

However, in this case, when the user intends to check simple information via the mobile terminal, if the mobile terminal asks the user to cancel the password, it may cause inconvenience of the user. Hence, the present invention proposes a mobile terminal capable of checking brief information provided by the mobile terminal by inputting a simple touch input to the mobile terminal in an idle state.

### DISCLOSURE OF THE INVENTION

### Technical Tasks

An object of the present invention is to provide a mobile terminal capable of enhancing user convenience and a method of controlling therefor.

Specifically, when a mobile terminal is in an idle state, an object of the present invention is to provide a mobile terminal capable of providing prescribed information in response to a touch input received from a user and a method of controlling therefor.

Another object of the present invention is to provide a mobile terminal capable of providing prescribed information in response to a rubbing touch input inputted on the mobile terminal and a method of controlling therefor to enable a user to handle the mobile terminal by one hand.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a mobile terminal includes a sensing unit configured to sense a tilt of the mobile terminal, a display unit configured to output information, and if a touch input is received via the display unit, a controller configured to control a list of recently executed applications to be outputted in response to the touch input, if the touch input is received in a state that the mobile terminal is laid horizontally, the controller configured to control a first application list, which is executed in a landscape mode, to be outputted, if the touch input is received in a state that the mobile terminal is laid vertically, the controller configured to control a second application list, which is executed in a landscape mode, to be outputted.

To further achieve these and other advantages and in accordance with the purpose of the present invention, according to a different embodiment, a method of controlling a mobile terminal, includes the steps of receiving a touch input rubbing a display unit and outputting a list of recently executed applications in response to the touch input. In this case, if the touch input is received in a state that the mobile terminal is laid horizontally, a first application list, which is executed in a landscape mode, is outputted. If the touch input is received in a state that the mobile terminal is laid vertically, a second application list, which is executed in a landscape mode, can be outputted.

Technical solutions obtainable from the present invention are non-limited the above-mentioned technical solutions. And, other unmentioned technical solutions can be clearly understood from the following description by those having ordinary skill in the technical field to which the present invention pertains.

### Advantageous Effects

Accordingly, the present invention provides the following effects or advantages.

According to one embodiment of the present invention, it is able to provide a mobile terminal capable of enhancing user convenience.

Specifically, when a mobile terminal is in an idle state, according to the present invention, it is able to provide a mobile terminal capable of providing prescribed information in response to a touch input received from a user and a method of controlling therefor.

According to the present invention, it is able to provide a mobile terminal capable of providing prescribed information in response to a rubbing touch input inputted on the mobile terminal and a method of controlling therefor to enable a user to handle the mobile terminal by one hand.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

FIG. 1a is a block diagram for explaining a mobile terminal according to the present invention;

FIGS. 1b and 1c are conceptual diagrams for an example of a mobile terminal according to the present invention seen from a different view;

FIG. 2 is a diagram for explaining an input condition of a rubbing touch;

FIG. 3 is a diagram for explaining an input condition of a rubbing touch;

FIG. 4 is a diagram for explaining an input condition of a rubbing touch;

FIG. 5 is a flowchart for a method of operating a mobile terminal according to the present invention;

FIG. 6 is a diagram for an example of outputting prescribed information via a display unit;

FIG. 7 is a diagram for an example of changing outputted information;

FIG. 8 is a flowchart for a method of operating a mobile terminal according to the present invention;

FIG. 9 is a diagram for an example of playing a multimedia file;

FIG. 10 is a diagram for a different example of playing a multimedia file;

FIG. 11 is a diagram for explaining an example of stopping the playback of a multimedia file;

FIG. 12 is a flowchart for a method of operating a mobile terminal according to the present invention;

FIG. 13 is a diagram for an example of outputting an icon for checking an event;

FIG. 14 is a diagram for an example of outputting detail content of an event;

FIG. 15 is a diagram for an example of executing an application in response to a selected event;

FIG. 16 is a flowchart for a method of operating a mobile terminal according to the present invention;

FIG. 17 is a diagram for an example of turning on/off a flash;

FIG. 18 is a flowchart for a method of operating a mobile terminal according to the present invention;

FIG. 19 is a diagram for an example of capturing a picture;

FIG. 20 is a diagram for an example of outputting a preview image or a captured picture;

FIG. 21 is a diagram for an example of outputting a preview image or a captured picture;

FIG. 22 is a flowchart for a method of operating a mobile terminal according to the present invention;

FIG. 23 is a diagram for an example of outputting a list of applications;

FIG. 24 is a diagram for an example of outputting a list of recently executed applications in a portrait mode and a landscape mode;

FIG. 25 is a diagram for an example of outputting a preview;

FIG. 26 is a diagram for an example of executing an application;

FIG. 27 is a flowchart for a method of operating a mobile terminal according to the present invention;

FIG. 28 is a diagram for an example of outputting a setting menu;

FIG. 29 is a diagram for an example of outputting a handler;

FIG. 30 is a diagram for an example of outputting a button for controlling a setting value of a mobile terminal;

FIG. 31 is a diagram for explaining an example of determining a position of a finger according to a moving trajectory of a pointer.

### BEST MODE

### Mode for Invention

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

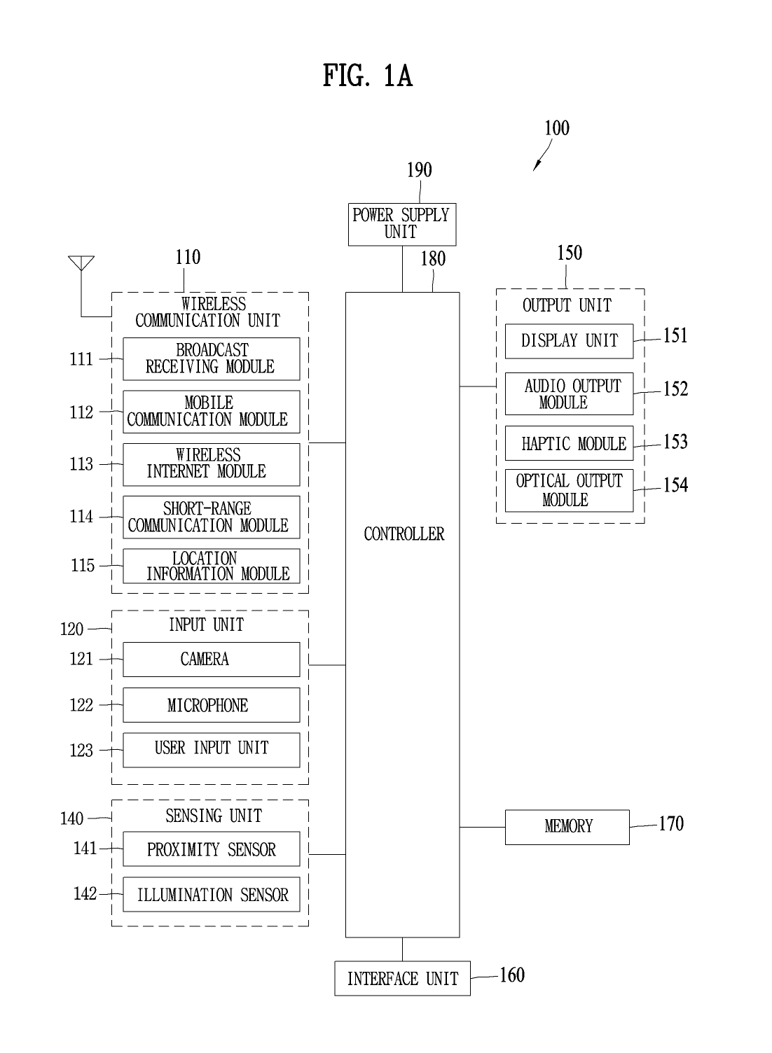

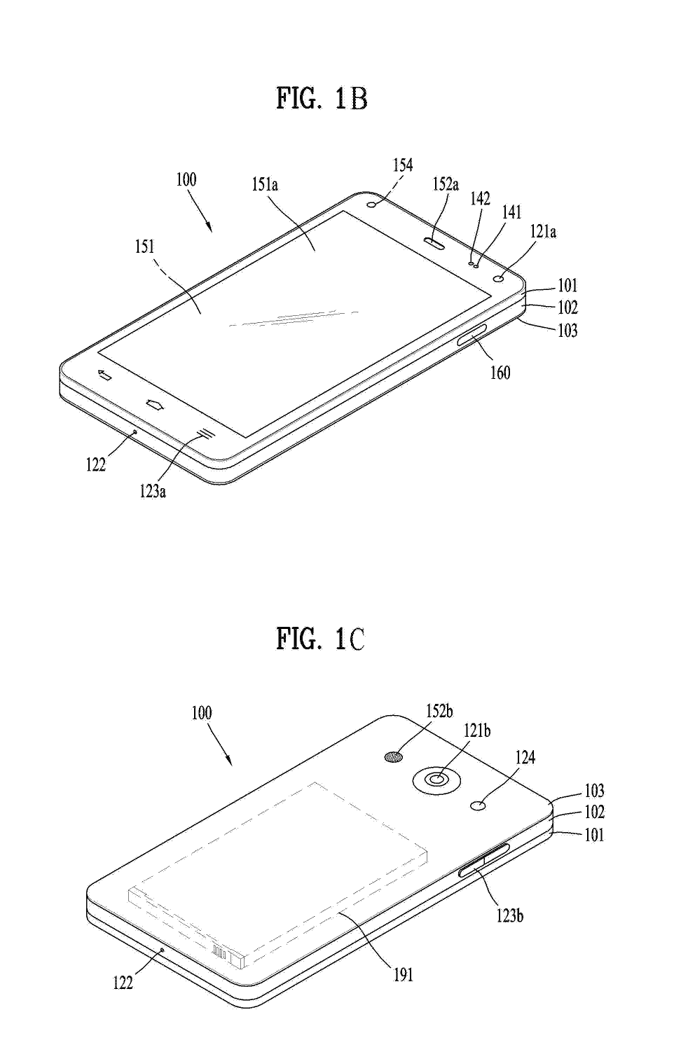

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

[[UX Part Start]]

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

[[3D Start]]

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

[[3D End]]

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

For clarity, assume that the mobile terminal according to the present invention includes at least one of the configuration elements shown in FIGS. 1a to 1c. For example, it may assume that the mobile terminal according to the present invention includes a camera 121, a sensing unit 140, a display unit 151, a memory 170, and a controller 180 among the configuration elements shown in FIGS. 1a to 1c.

In the following, assume that the display unit 151 corresponds to a touch screen. If the display unit 151 corresponds to a touch screen, the display unit 151 can function not only as an input device for receiving a touch input but also as an output device for outputting information.

If the display unit 151 corresponds to a touch screen, a touch input of various types can be received via the display unit 151. For example, a touch input touching the display unit 151 one time, a long touch input touching the display unit 151 for more than prescribed time, a touch input tapping the display unit 151 more than a prescribed count, a drag or flicking input for moving a pointer touching the display unit 151 in a prescribed direction, and the like can be received via the display unit 151.

A touch input rubbing the display unit 151 can be received via the display unit 151 (hereinafter, the touch input rubbing the display unit 151 is referred to as a rubbing touch). If a pointer touching the display unit 151 is sensed and a movement of the pointer satisfies a prescribed condition, the controller 180 can recognize it as a rubbing touch is inputted.

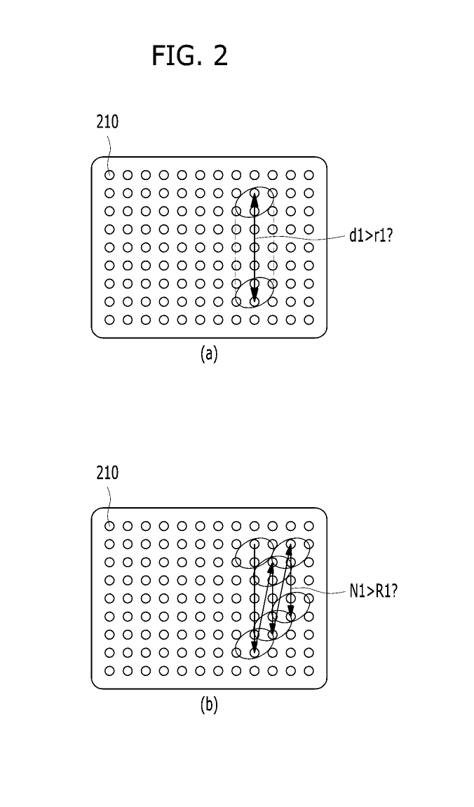

For example, FIG. 2 is a diagram for explaining an input condition of a rubbing touch. In FIGS. 2 (a) and (b), an oval indicates a position at which a pointer is touched and a dotted line and an arrow indicate a moving path of a pointer touching the display unit 151.

If the display unit 151 corresponds to a touch screen, a touch pad can be attached to the other side of the display unit 151. A plurality of sensing points 210 (or, touch sensors) may exist on the touch pad and the controller 180 can recognize a touch position of a pointer based on a sensing signal sensed at each sensing point.

As shown in FIG. 2 (a), if a maximum moving distance (d1) of a pointer rubbing the display unit 151 is equal to or greater than a first reference value (r1) (i.e., a maximum distance between a plurality of sensing points at which a touch of the pointer is sensed), or as shown in FIG. 2 (b), if the count (N1) of moving back and forth of a pointer is equal to or greater than a predetermined count (R1), the controller 180 can determine it as a rubbing touch is received. Or, if a movement of a pointer satisfying the conditions shown in FIGS. 2 (a) and (b) is sensed, the controller 180 can determine it as a rubbing touch is received.

In the example shown in FIG. 2 (a), if the maximum moving distance of the pointer is too long (e.g., if the moving distance of the pointer is equal to or greater than a second reference value), the controller may determine it as a rubbing touch is not inputted.

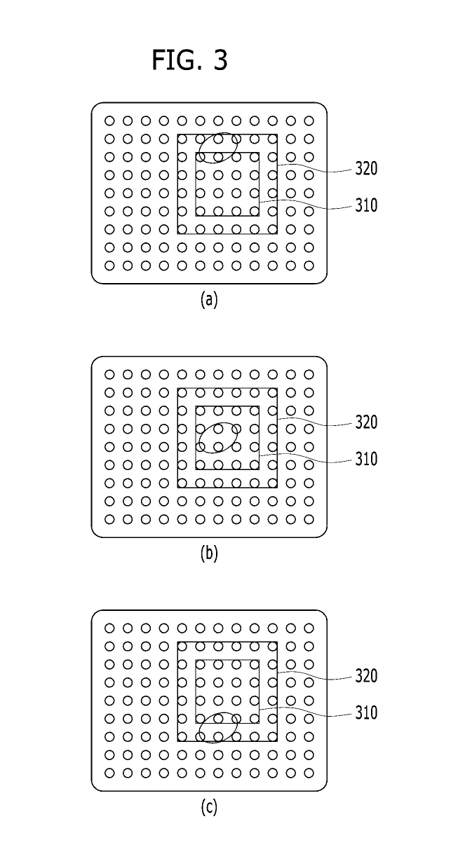

FIG. 3 is a diagram for explaining an input condition of a rubbing touch. When a first region 310 and second region 320 surrounding the first region (yet, the second region 320 does not include the first region 310) are set on a touch pad, if a pointer moves back and forth on the second region 320 to repeatedly touch and release the second region while consistently touching the first region 310, the controller 180 can determine it as a rubbing touch is inputted. For example, as shown in FIGS. 3 (a) to (c), if an action of touching the first region 310 and the second region 320 at the same time->touching the first region 310->touching the first region 310 and the second region 320 at the same time is repeated more than a prescribed count in a manner that the pointer is dragged, the controller 180 can determine it as a rubbing touch is inputted.

FIGS. 3 (a) to (c) show a case that a plurality of sensing points exist on the first region 310 and the second region 320. Unlikely, a single sensing point may exist on the first region 310 and the second region 320.

When the first region 310 and the second region 320 are configured, the controller 180 may consider a moving trajectory of a pointer touching the display unit 151. For example, if the pointer is dragged to a second point from a first point on the display unit 151, the first region 310 can be configured between the first point and the second point and the second region 320 can be configured at the outside of the first point and the second point.

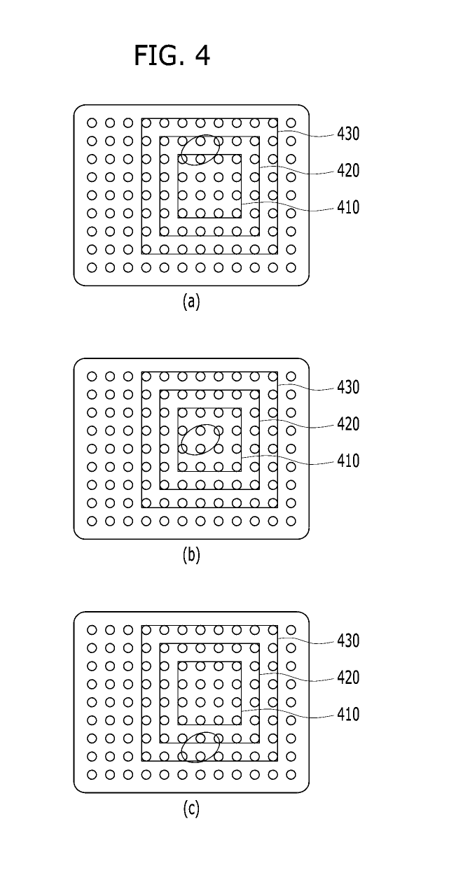

FIG. 4 is a diagram for explaining an input condition of a rubbing touch. The controller 180 can configure a first region 410, a second region 420, and a third region 430 surrounding the second region 420. If a touch of a pointer touching the first region 410 is maintained, a touch and release on the second region 420 is repeated more than a prescribed count, and the third region 430 is not touched, the controller 180 can determine it as a rubbing touch is inputted.

As an example, as shown in FIGS. 4 (a) to (c), if a pointer touches the third region 430 in the middle of moving back and forth on the second region 420 on the basis of the first region 410 (refer to FIG. 4 (c)), the controller 180 can determine it as a rubbing touch is not inputted.

As a different example, although the third region 430 is touched, if the third region 430 is touched as many as a count equal to or less than a prescribed count, or if a touch count of the third region 430 is less than a touch count of the second region 420, the controller 180 can determine it as a rubbing touch is inputted.

Although a mobile terminal is in an idle state, the controller 180 can receive a touch input touching the display unit 151. In this case, the idle state may correspond to a state that the mobile terminal is not used. In order to reduce unnecessary power consumption, the display unit 151 can maintain an off state (or inactivate state) in the idle state of the mobile terminal. In this case, the off state of the display unit 151 corresponds to a state that a light for lighting the display unit 151 is turned off. Information or a graphic image is not outputted on the display unit 151 in the off state of the display unit 151. Although the display unit 151 is in the off state, a touch panel maintains an active state to sense a touch input touched on the display unit 151. Yet, when the mobile terminal is in the idle state, a period of activating a sensing point on a touch pad may be longer than a period when the mobile terminal is not in the idle state.

On the contrary, a state that the display unit 151 is turned on (or, activated state) corresponds to a state that a light for lighting the display unit 151 is turned on. In the state that the display unit 151 is turned on, information or a graphic image can be outputted according to a control of the controller 180.

If the idle state of the mobile terminal ends, the display unit 151 may enter a semi active state. The semi active state may correspond to a state that a part of the display unit 151 is turned off and the rest of the display unit is turned on. In this case, information or a graphic image is not outputted on a part where the display unit 151 is turned off. Yet, information or a graphic image can be outputted on a part where the display unit 151 is turned on.

For clarity, a state that the mobile terminal is deviated from the idle state is referred to as a normal state. In the normal state, the display unit 151 can maintain a state that the entire display unit is activated or a state that a part of the display unit is activated.

As mentioned in the foregoing description, a mobile terminal according to the present invention can receive a touch input of various types in an idle state. The present invention intends to propose various methods of operating the mobile terminal via a rubbing touch when the mobile terminal is in the idle state. In the following, each of embodiments is explained as a separate category. Yet, it is apparent that each of the embodiments can be applied to a single mobile terminal.

In the following, the mobile terminal according to the present invention is explained in detail.

<Information Display>

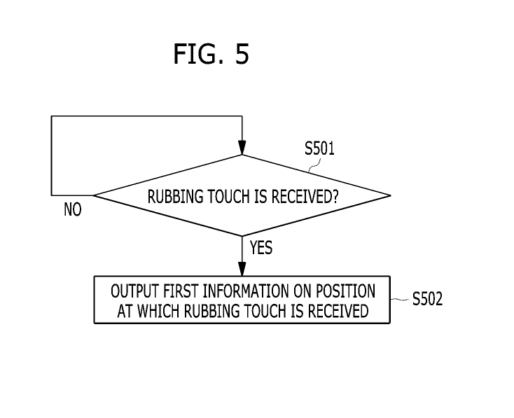

FIG. 5 is a flowchart for a method of operating a mobile terminal according to the present invention. Assume that the mobile terminal is initially laid in an idle state.

Referring to FIG. 5, if a rubbing touch is received via the display unit 151 [S501], the controller 180 switches the mobile terminal into a normal state and controls prescribed information to be outputted via a position at which the rubbing touch is received [S502]. In this case, the information outputted via the display unit 151 can include weather information, time information, date information, or event information (In this case, an event can include message reception, e-mail reception, occurrence of an unanswered call, and the like.).

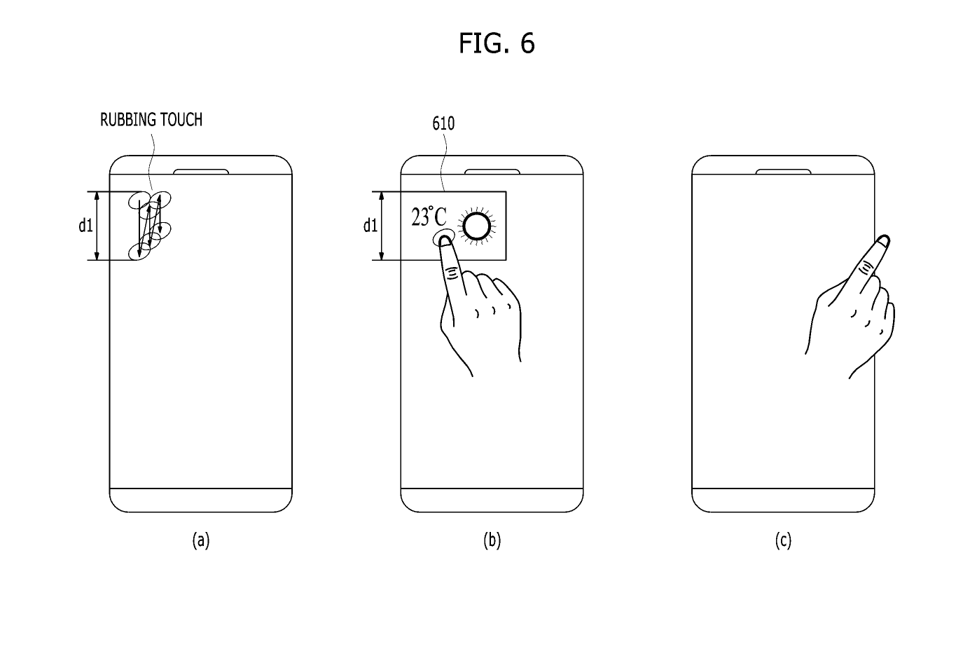

For example, FIG. 6 is a diagram for an example of outputting prescribed information via a display unit. As shown in the example of FIG. 6 (a), if a touch input rubbing the display unit 151 is received, as shown in FIG. 6 (b), the controller 180 can control prescribed information to be outputted. FIG. 6 (b) shows an example that weather information 610 is outputted in response to a rubbing touch.

The controller 180 can control the prescribed information to be outputted at a position at which the rubbing touch is received. Moreover, the controller 180 can configure at least one of a horizontal length and a vertical length of the prescribed information in accordance with a moving length of a pointer, which have inputted the rubbing touch horizontally or vertically.

For example, as shown in FIG. 6 (a), if a maximum moving length of a pointer, which has moved vertically to input a rubbing touch, corresponds to d1, the controller 180 can control a vertical length of the displayed information 610 to be configured by d1 as well.

The controller 180 can control prescribed information to be outputted while turning on the whole of the display unit 151. Or, the controller 180 can control a region on which the prescribed information 610 is to be outputted to be turned on only among the entire region of the display unit 151. In this case, the controller 180 can control the remaining region to maintain an off state.

The controller 180 can control the prescribed information 610 to be outputted only when the pointer, which has inputted the rubbing touch, touches the display unit 151. Specifically, if the pointer, which has inputted the rubbing touch, touches the display unit 151, as shown in the example of FIG. 6 (b), the controller 180 controls the prescribed information to be outputted. If the pointer, which has inputted the rubbing touch, is released from the display unit 151, as shown in the example of FIG. 6 (c), the controller can control the prescribed information not to be outputted. In this case, the controller 180 turns off the display unit 151 and can control the mobile terminal to enter an idle state.

When the prescribed information is outputted, if the pointer is dragged to the outside of a region on which the prescribed information is outputted, the controller 180 can control other information to be outputted.

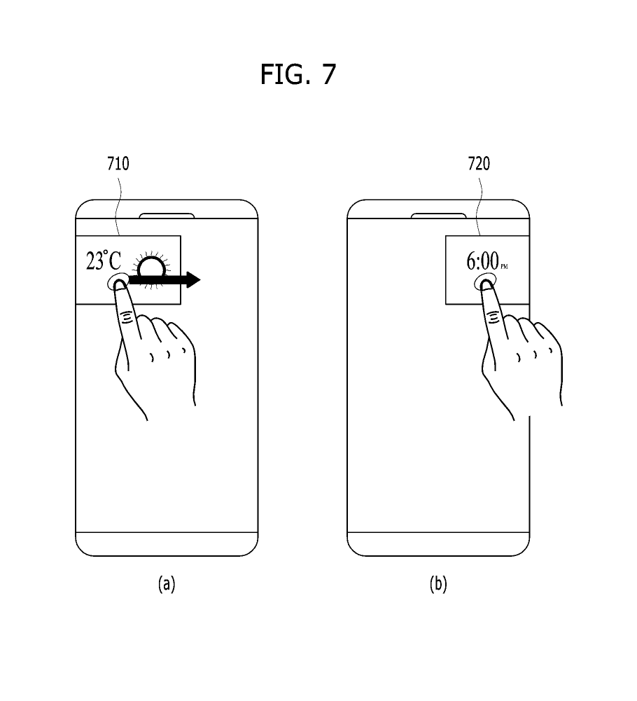

For example, FIG. 7 is a diagram for an example of changing outputted information.

If a rubbing touch is inputted, the controller 180 can control first information 710 to be outputted in response to the rubbing touch. FIG. 7 (a) shows an example that weather information is outputted in response to the rubbing touch. In this case, if a pointer moves to the outside of a region on which the first information 710 is outputted, the controller 180 stops outputting the first information 710 and can control second information 720 to be outputted.

For example, if the pointer moves to the outside of the region on which the weather information 710 is outputted, as shown in the example of FIG. 7 (b), the controller 180 stops outputting the weather information 710 and can control time information 720 to be outputted.

In this case, a position at which the second information 720 is outputted can be determined based on a position to which the pointer is dragged. For example, referring to FIG. 7, as the pointer is dragged to the right side of the weather information 710, the time information 720 is outputted at the right side of the weather information 710.

<Playing Multimedia File>

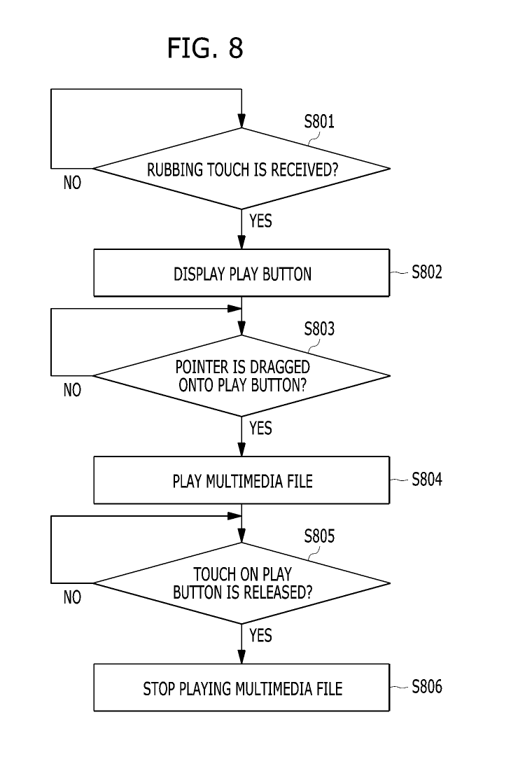

FIG. 8 is a flowchart for a method of operating a mobile terminal according to the present invention. Assume that the mobile terminal is initially laid in an idle state.

Referring to FIG. 8, if a rubbing touch is received via the display unit 151 [S801], the controller 180 can control a play button for playing a multimedia file to be outputted near a position to which the rubbing touch is inputted [S802]. In this case, the multimedia file can include a music file or a video file. The music file or the video file may correspond to a file stored in the memory 170 or a server.

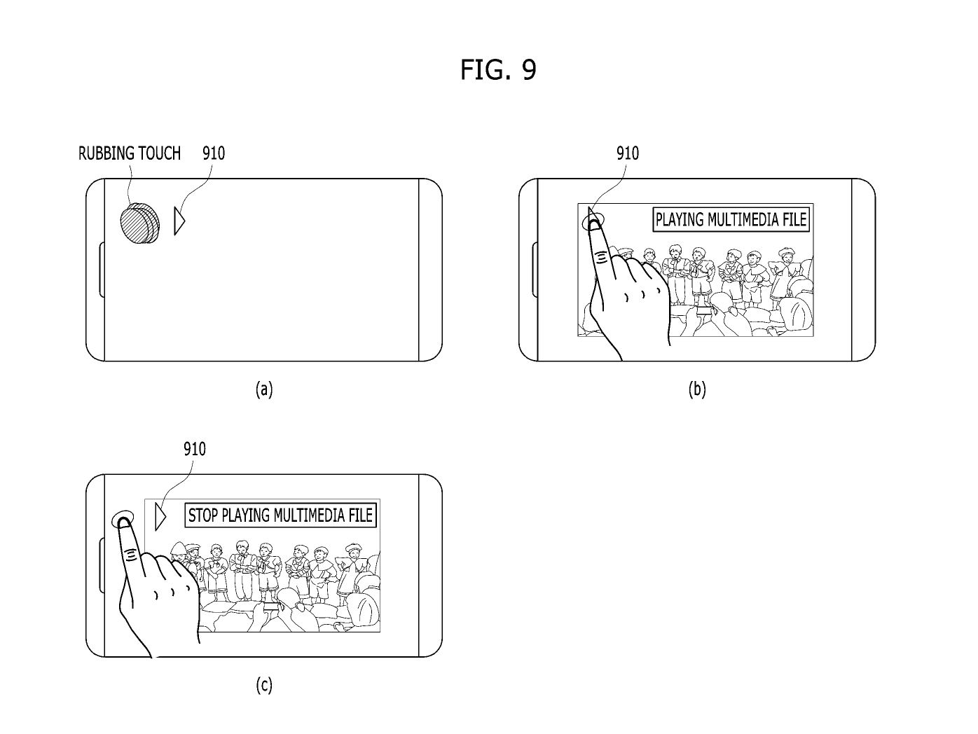

If a pointer is dragged onto the play button [S803], the controller 180 can play the multimedia file [S804]. An example of playing the multimedia file is explained in detail with reference to FIG. 9 in the following.

FIG. 9 is a diagram for an example of playing a multimedia file.

If a rubbing touch is received, as shown in the example of FIG. 9 (a), the controller 180 can control a play button 910 for playing a multimedia file to be outputted at a position to which the rubbing touch is inputted or a position near the position to which the rubbing touch is inputted. FIG. 9 (a) shows an example of outputting the play button 910 at the position near the position to which the rubbing touch is inputted.

Subsequently, as shown in the example of FIG. 9 (b), if the pointer touching the display unit 151 is dragged onto the play button 910, the controller 180 can control the multimedia file to be played. In this case, the multimedia file may correspond to a most recently listened multimedia file by a user or a multimedia file selected by the user in advance.

If the pointer deviates from the play button [S805], the controller 180 can stop playing the multimedia file [S806].

In this case, although the pointer has deviated from the play button, if the pointer is still touching the display unit 151, the controller 180 can control the mobile terminal to maintain a normal state. On the contrary, if the touch of the pointer, which has deviated from the play button, is released from the display unit 151, the controller 180 can control the mobile terminal to reenter an idle state.

In particular, the controller 180 can control the mobile terminal to maintain the normal state only when the pointer touches the display unit 151.

For example, as shown in the example of FIG. 9 (c), although the pointer has deviated from the play button 910, if the pointer is still touching the display unit 151, the controller 180 can stop playing the multimedia file, whereas the display unit 151 can continuously maintain the on state.

Although a touch of the pointer is released from the display unit 151, the controller 180 can control the multimedia file to be continuously played according to a configuration of a user.

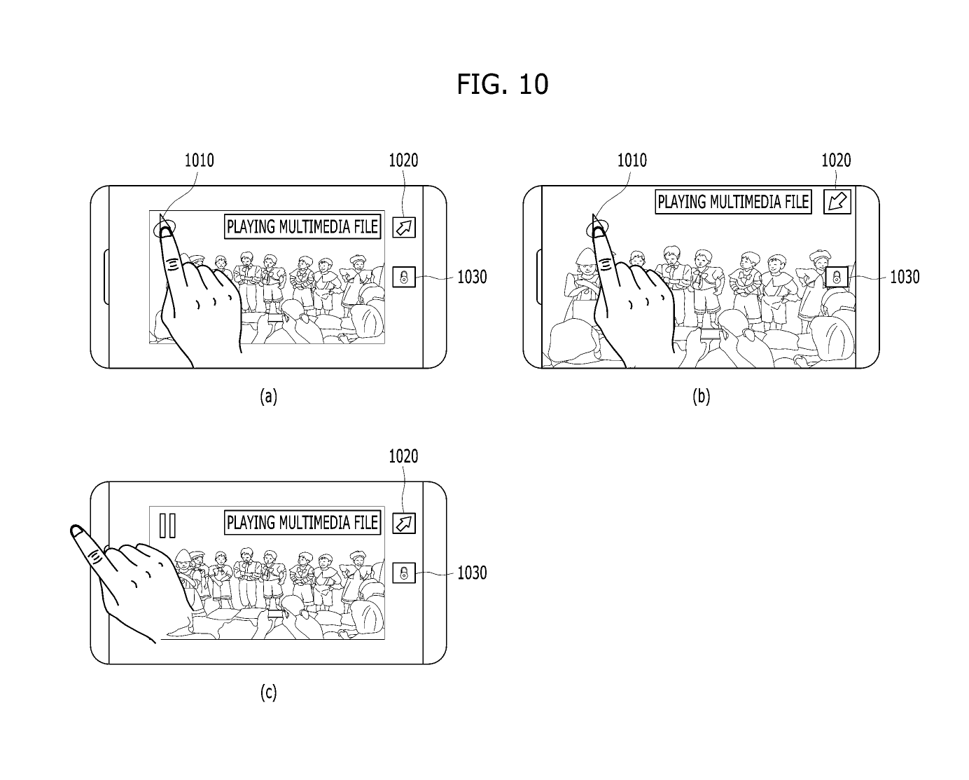

For example, FIG. 10 is a diagram for a different example of playing a multimedia file.

If a play button 1010 is touched, the controller 180 can start to play the multimedia file. If the playback of the multimedia file starts, as shown in the example of FIG. 10 (a), the controller 180 can control a full screen button 1020 for watching the multimedia file in full screen and a continuous play button 1030 for continuously playing the multimedia file although the play button 1010 is not touched to be outputted.

Referring to the example shown in FIG. 10 (a), if the full screen button 1020 is touched, as shown in the example of FIG. 10 (b), the controller 180 can control the multimedia file to be played in full screen. If the full screen button 1020 is retouched while the multimedia file is played in full screen, as shown in the example of FIG. 10 (a), the controller 180 can control the multimedia file to be outputted via a partial region of the display unit 151 again.

If the pointer touching the play button 1010 is dragged onto the full screen button 1020 or a different pointer touches the full screen while the play button 1010 is touched by the pointer, the controller 180 can control the multimedia file to be played in full screen.

Referring to the example shown in FIG. 10 (a), if the continuous play button 1030 is touched, as shown in FIG. 10 (c), although the touch of the pointer is released from the display unit 151, the controller 180 can control the multimedia file to be continuously played.

In this case, the touch input touching the play button 1010 can be inputted by dragging the pointer touching the play button 1010 to the continuous play button 1030 or touching the continuous play button 1030 by a different pointer while the play button 1010 is touched.

If the continuous play button 1030 is touched, although the pointer does not touch the display unit 151, the controller 180 can control the multimedia file to be continuously played. In this case, the controller 180 outputs a stop button 1040 for stopping the playback of the multimedia file. If the sop button 1040 is touched, the controller can stop playing the multimedia file.

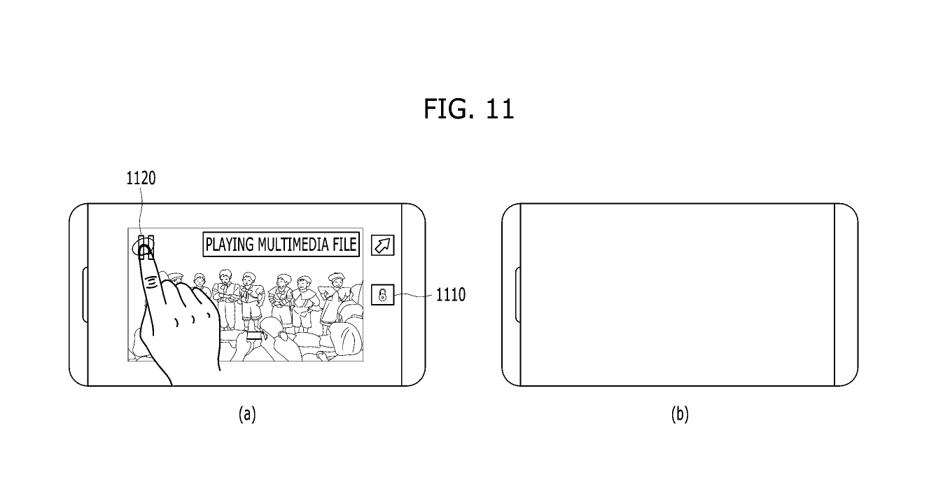

For example, FIG. 11 is a diagram for explaining an example of stopping the playback of a multimedia file.

If a continuous play button 1110 is touched, although a pointer does not touch the display unit 151, the controller 180 can play a multimedia file. If the continuous play button 1110 is touched, as shown in the example of FIG. 11 (a), the controller 180 can output a stop button 1120 for terminating the playback of the multimedia file via the display unit 151.

If the stop button 1120 is touched, the controller 180 can stop playing the multimedia file. When the playback of the multimedia file is stopped, as shown in the example of FIG. 11 (b), the controller 180 can control the mobile terminal to enter an idle state.

In particular, if the touch of the pointer is released from the display unit 151 before the continuous play button 1110 is selected, the mobile terminal enters the idle state. Yet, if the stop button 1120 is selected after the continuous play button 1110 is selected, the mobile terminal can enter the idle state.

<Checking Message>

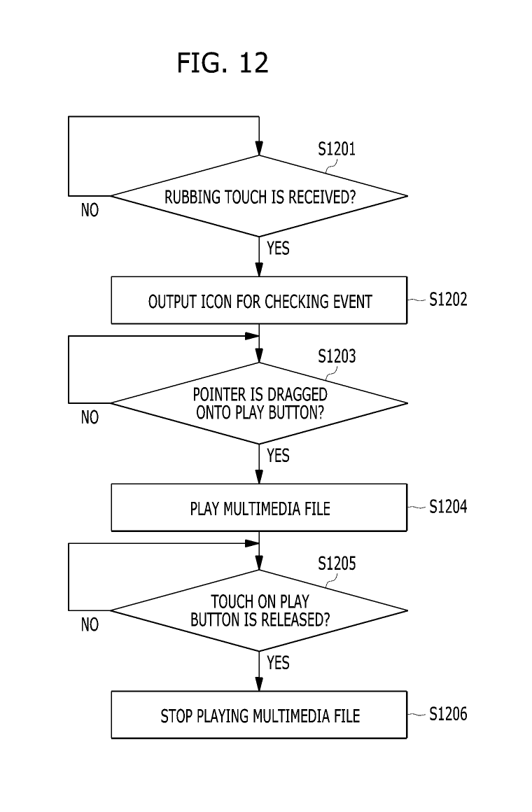

FIG. 12 is a flowchart for a method of operating a mobile terminal according to the present invention. Assume that the mobile terminal is initially laid in an idle state. And, assume that a new event has occurred in the mobile terminal. In this case, the event can include message reception, e-mail reception, occurrence of an unanswered call, and the like.

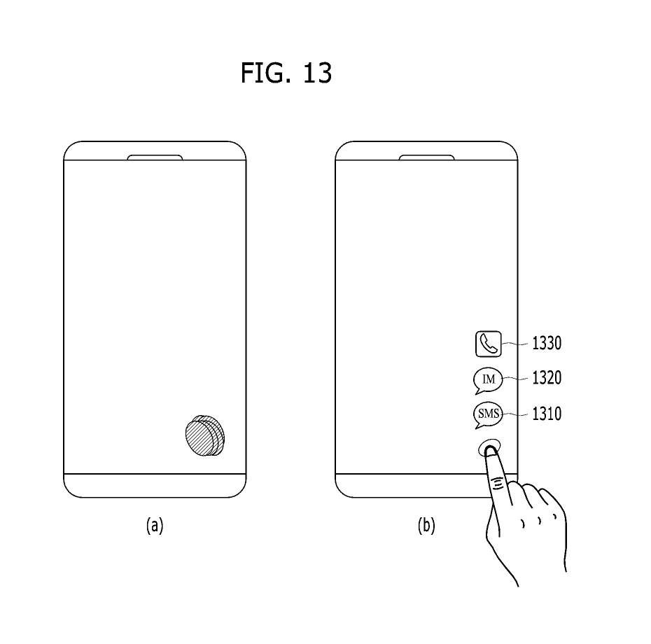

Referring to FIG. 12, if a rubbing touch is received via the display unit 151 [S1201], the controller 180 can control an icon for checking an event to be outputted [S1202]. In this case, the icon may correspond to an icon of an application capable of checking detail contents of an event. For example, if a text message is received in the mobile terminal, the icon outputted by the rubbing touch may correspond to an icon of a text message application. An example of outputting an icon is explained with reference to FIG. 13 in the following.

FIG. 13 is a diagram for an example of outputting an icon for checking an event. As shown in FIG. 13 (a), if a touch input rubbing the display unit 151 is received, as shown in the example of FIG. 13 (b), the controller 180 can control an icon for checking an event to be displayed. FIG. 13 (b) shows the example that a text message icon 1310 for checking a text message, an instant message icon 1320 for checking an instant message, and an unanswered call icon 1330 for checking an unanswered call are outputted.

If a pointer touching the display unit 151 is dragged onto a displayed icon [S1203], the controller 180 can control detail content of an event to be outputted [S1204].

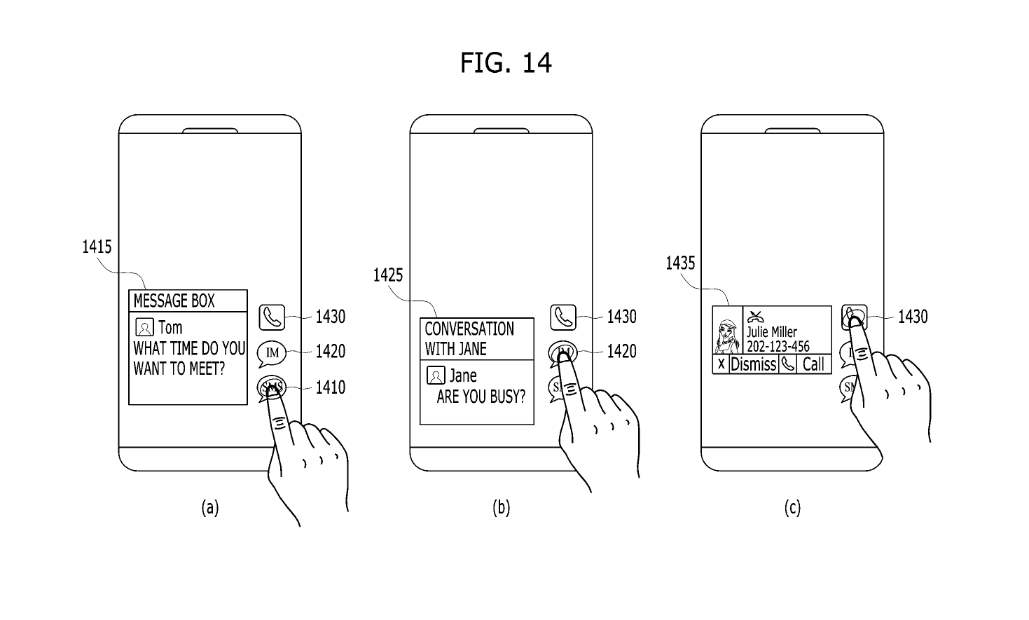

For example, FIG. 14 is a diagram for an example of outputting detail content of an event.

If a pointer touching the display unit 151 is dragged onto the text message icon 1410, as shown in the example of FIG. 14 (a), the controller 180 can control a pop-up window 1415 including detail content of a received text message to be outputted via the display unit 151.

If the pointer is dragged to the instant message icon 1420 from the text message icon, as shown in the example of FIG. 14 (b), the controller 180 can control a pop-up window 1425 including detail content of a received instant message to be outputted via the display unit 151.

If the pointer is dragged to the unanswered call icon 1430 from the instant message icon, as shown in the example of FIG. 14 (c), the controller 180 can control a pop-up window 1435 including detail content of an unanswered call to be outputted via the display unit 151.

In the examples shown in FIGS. 13 and 14, the controller 180 can control a region on which an application icon or detail information of an event is outputted to maintain on state and control the remaining region to maintain off state.

In addition, in the examples shown in FIGS. 13 and 14, if a touch of the pointer is released from the display unit 151, the controller 180 can stop outputting an icon or detail information. While the output of the icon or the detail information is stopped, the controller 180 can configure the mobile terminal to enter an idle state. In particular, the controller 180 can control the mobile terminal to maintain the normal state only when the pointer touches the display unit 151.

Unlikely, if the pointer is dragged to detail content of an event from a specific icon or the touch of the pointer is released from the display unit 151 after the pointer is dragged to the detail content of the event [S1205], the controller 180 can execute an application corresponding to the selected event [S1206].

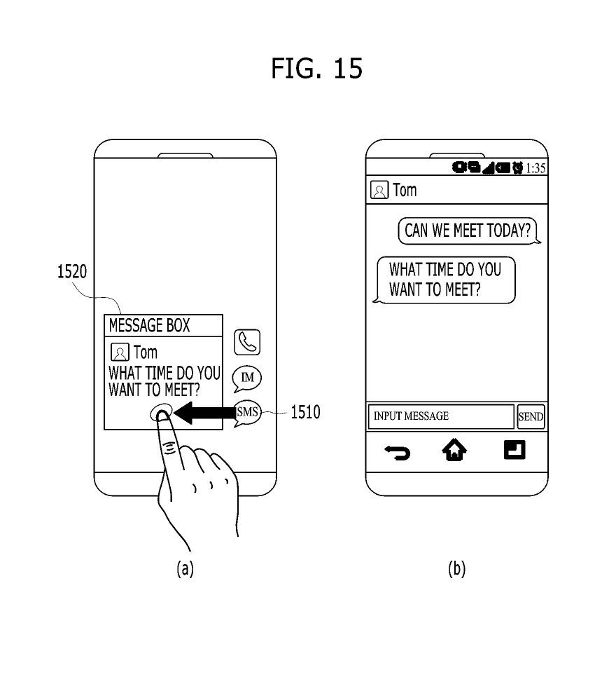

For example, FIG. 15 is a diagram for an example of executing an application in response to a selected event.

As shown in the example of FIG. 15 (a), if a pointer touching a text message icon 1510 is dragged to a pop-up window 1520 including detail content of a text message, the controller 180 can execute a text message application. In this case, as shown in the example of FIG. 15 (b), the controller 180 can control message content transceived with a counterpart (i.e., a counterpart who has sent the message) to be outputted while executing the text message application.

Although it is not depicted, if the pointer is dragged to a pop-up window including detail content of an instant message from an instant message icon, the controller 180 can execute an instant message application. In this case, the controller 180 can control a conversation window with a counterpart (i.e., a counterpart who has sent the instant message) to be outputted while executing the instant message application.

Although it is not depicted, if the pointer is dragged to a pop-up window including detail content of an unanswered call from an unanswered call icon, the controller 180 can execute a call application. In this case, the controller 180 can control a telephone number of a counterpart (i.e., a counterpart who has made the unanswered call) to be inputted to a dial screen of the call application. By doing so, a user can easily make a call to the person who has made the unanswered call.

<Flash On/Off>

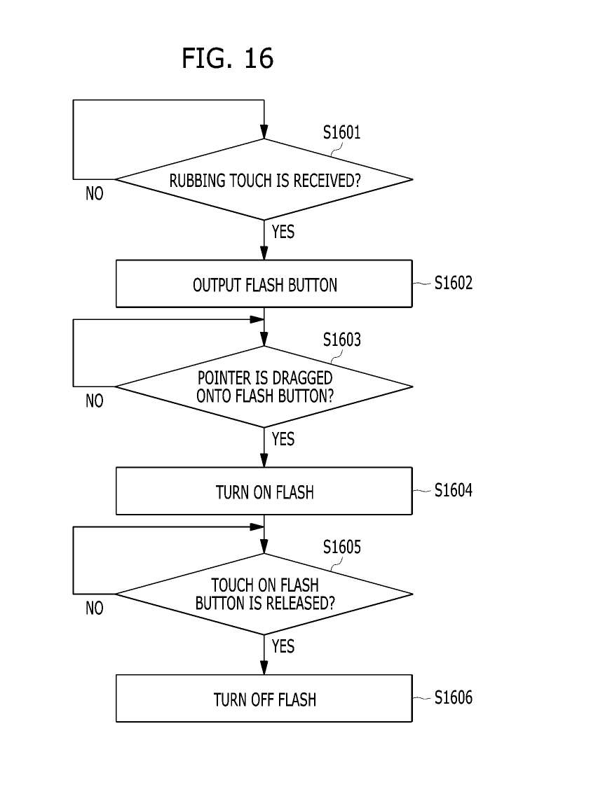

FIG. 16 is a flowchart for a method of operating a mobile terminal according to the present invention. Assume that the mobile terminal is initially laid in an idle state.

Referring to FIG. 16, if a rubbing touch is received via the display unit 151 [S1601], the controller 180 can control a flash button for turning on a flash to be outputted [S1602]. If the pointer is dragged to the flash button, the controller 180 can turn on the flash [S1604].

If the pointer deviates from the flash button [S1605], the controller 180 can turn off the flash [S1606].

In this case, although the pointer has deviated from the flash button, if the pointer is still touching the display unit 151, the controller 180 can control the flash button to be continuously outputted via the display unit 151. Unlikely, if the touch of the pointer, which have deviated from the flash button, is released from the display unit 151, the controller 180 can configure the mobile terminal to enter an idle state while turning off the display unit 151.

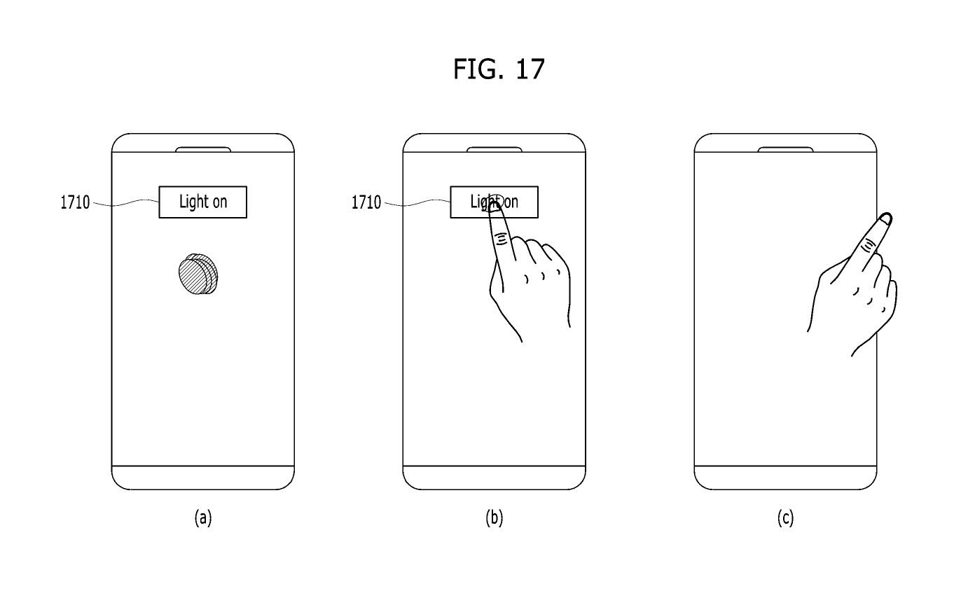

FIG. 17 is a diagram for an example of turning on/off a flash.

If a rubbing touch input is received via the display unit 151, as shown in the example of FIG. 17 (a), the controller 180 can control a flash button 1710 to be outputted. If a pointer touching the display unit 151 is dragged to the flash button 1710, as shown in the example of FIG. 17 (b), the controller 180 can control the flash to be turned on.

In the example shown in FIG. 17, the controller 180 can control a region on which the flash button 1710 is to be outputted to maintain on state and control the remaining region to maintain off state.

Subsequently, if the pointer deviates from the flash button 1710, the controller 180 can turn off the flash. In this case, if the touch of the pointer is released from the display unit 151, as shown in the example of FIG. 17 (c), the controller 180 can control the mobile terminal to enter an idle state while turning off the flash.

<Capturing Picture>

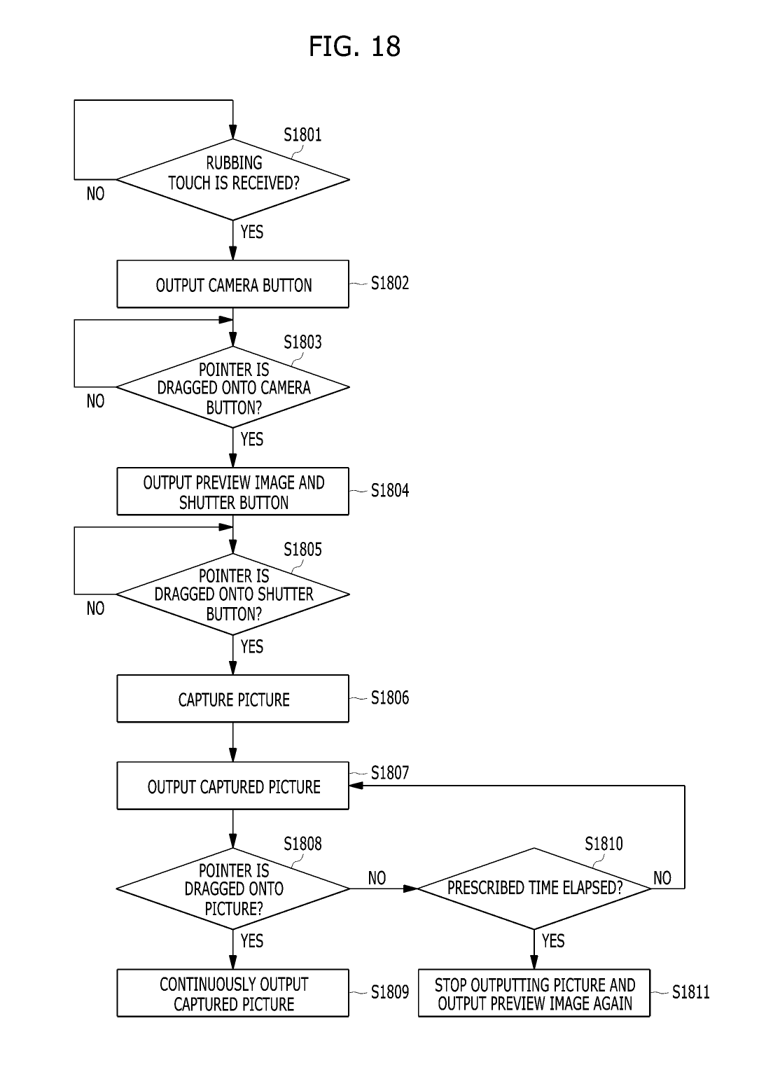

FIG. 18 is a flowchart for a method of operating a mobile terminal according to the present invention. Assume that the mobile terminal is initially laid in an idle state.

Referring to FIG. 18, if a rubbing touch is received via the display unit 151 [S1801], the controller 180 can control a camera button for activating a camera 121 to be outputted [S1802]. If a pointer is moved to the camera button 121 [S1803], the controller 180 activates the camera 121 and can control a preview image to be outputted via the display unit 151 [S1804].

In this case, the preview image may correspond to an image inputted in real time via the camera 121 before a picture or a video is captured.

If the preview image is outputted, the controller 180 can control a shutter button (or capturing button) to be additionally outputted [S1804]. If a pointer is dragged onto the shutter button [S1805], the controller 180 can control the camera 121 to capture a picture [S1806].

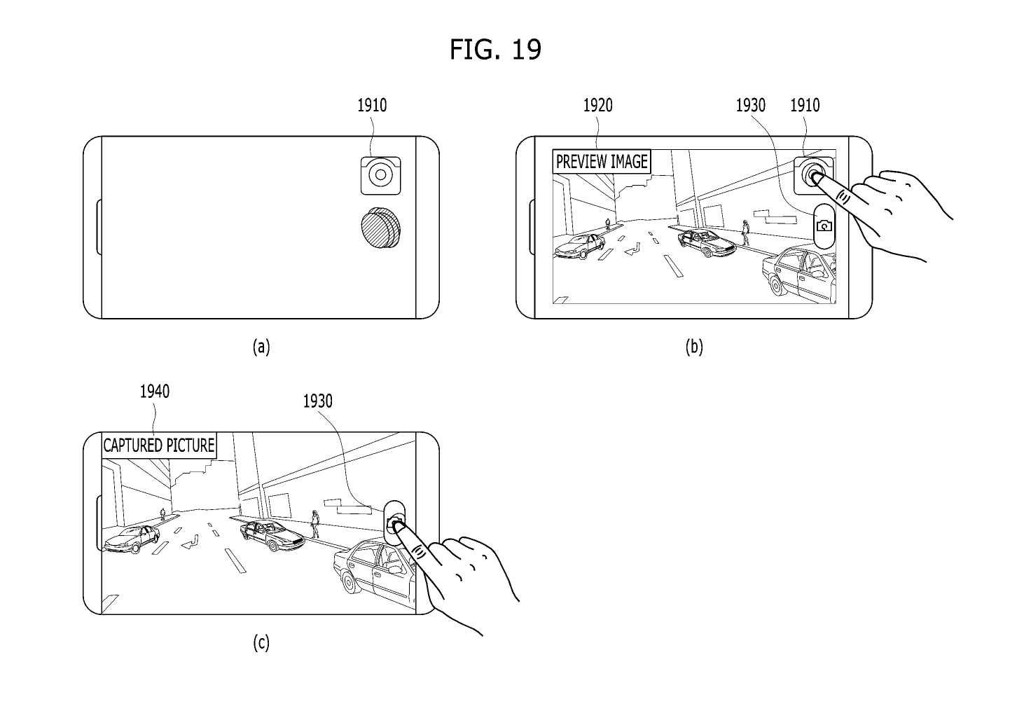

For example, FIG. 19 is a diagram for an example of capturing a picture.

If a rubbing touch is received, as shown in an example of FIG. 19 (a), the controller 180 can control a camera button 1910 for activating a camera 121 to be outputted. In this case, the controller 180 can control a region on which the camera button 1910 is outputted to maintain on state and control the remaining region to maintain off state among the entire region of the display unit 151.

If the pointer is dragged onto the camera button 1910, the controller 180 activates the camera 121, and as shown in the example of FIG. 19 (b), the controller can control a preview image 1920, which is inputted in real time via the camera 121, to be outputted.

In this case, the controller 180 can control a shutter button 1930 to be outputted together with the preview image 1920. If the pointer is dragged onto the shutter button 1930, the controller 180 can control the camera 121 to capture a picture. In this case, the controller 180 can capture a picture after performing auto focusing on a specific subject.

If a picture is captured, as shown in the example of FIG. 19 (c), the controller 180 can control the captured picture to be outputted via the display unit 151 [S1807].

In the example shown in FIG. 19, if a touch of the pointer is released from the display unit 151, the controller 180 deactivate the camera 121 and can control the mobile terminal to enter an idle state. In particular, the controller 180 can control the mobile terminal to maintain the normal state only when the pointer touches the display unit 151.

If prescribed time elapses after the captured picture is outputted [S1810], the controller 180 stops outputting the captured picture and can control the preview image to be outputted again [S1811].

Meanwhile, if a touch input for dragging the pointer onto a picture, which is outputted via the display unit 151, is received before prescribed time elapses [S1808], the controller 180 can control the captured picture to be continuously outputted [S1809]. In this case, although the touch of the pointer is released from the display unit 151, the controller 180 can control the picture to be continuously outputted via the display unit 151.

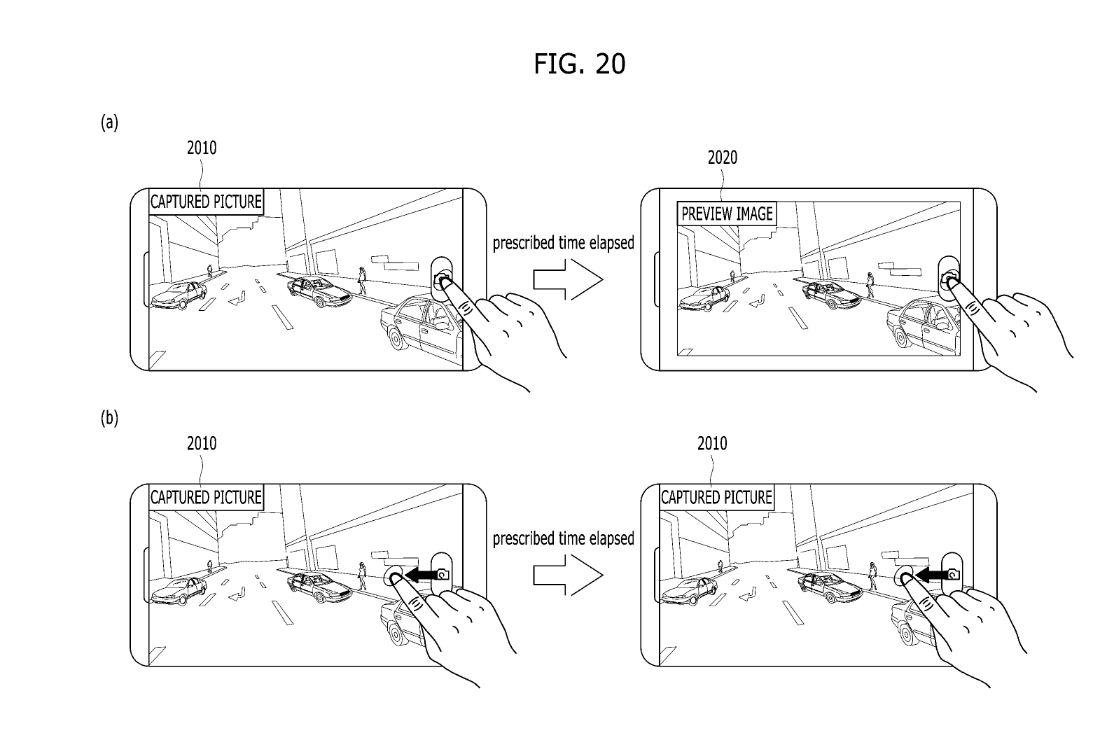

FIG. 20 is a diagram for an example of outputting a preview image or a captured picture.

If a picture is captured, as mentioned earlier with reference to FIG. 19 (c), the controller 180 can control the captured picture to be outputted via the display unit 151.

In this case, when prescribed time elapsed after the picture is captured, if an additional touch input of a predetermined type (e.g., a touch input for dragging a pointer onto the captured picture 2010) is not received, as shown in the example of FIG. 20 (a), the controller 180 stops outputting the captured picture 2010 and can control a preview image 2020 to be outputted.

Meanwhile, if an additional touch input of a predetermined type (e.g., a touch input for dragging a pointer onto the captured picture 2010) is received before prescribed time elapses, as shown in an example of FIG. 20 (b), the controller 180 can control the captured picture 2010 to be continuously outputted although the prescribed time elapses.

Unlike the example shown in FIG. 20, when a picture is captured, the controller 180 can control the captured picture to be outputted while a touch touching a shutter button is maintained. If the touch touching the shutter button is released, the controller 180 can controller 180 can control a preview image to be outputted.

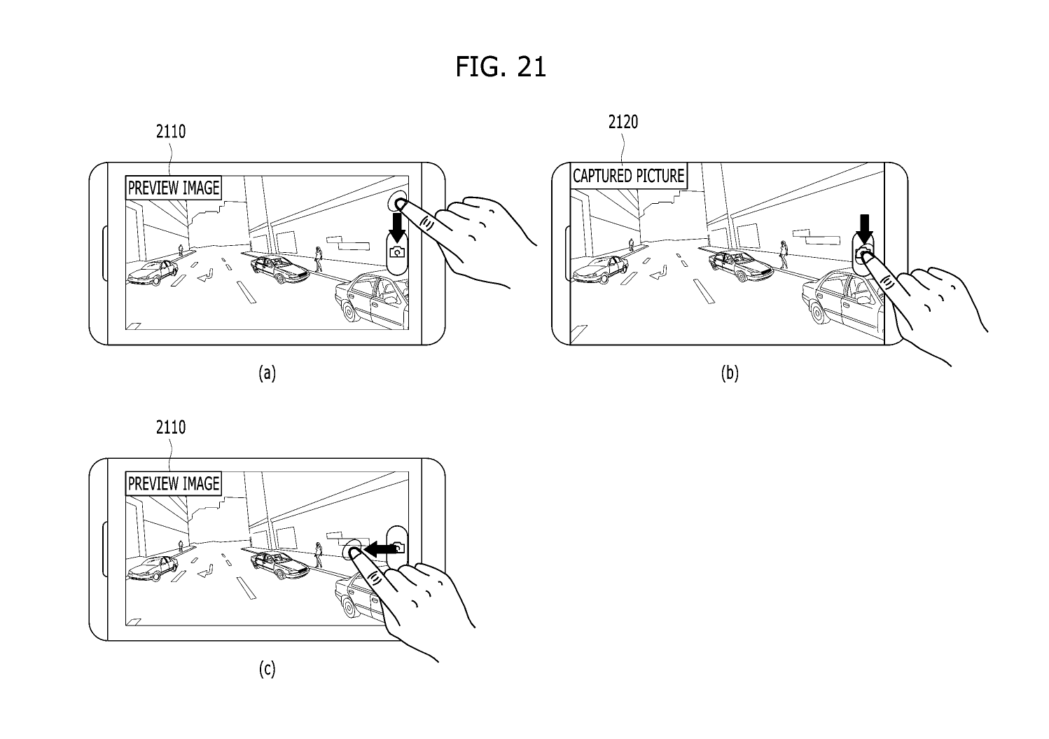

For example, FIG. 21 is a diagram for an example of outputting a preview image or a captured picture.

As shown in the example of FIGS. 21 (a) and (b), if a pointer is moved to a shutter button, the controller 180 captures a picture 2120 in response to the movement of the pointer and can control the captured picture 2120 to be outputted.

In this case, if a touch touched on the shutter button is maintained, the controller 180 can control the captured picture 2120 to be continuously outputted while the touch touched on the shutter button is maintained.

Meanwhile, if the pointer deviates from the shutter button, as shown in the example of FIG. 21 (c), the controller 180 stops outputting the captured picture 2120 and can control a preview image 2110 to be outputted. If a user drags the pointer onto the shutter button while the preview image 2110 is outputted, it may be able to capture a picture 2120 again.

<Outputting List of Recently Executed Applications>

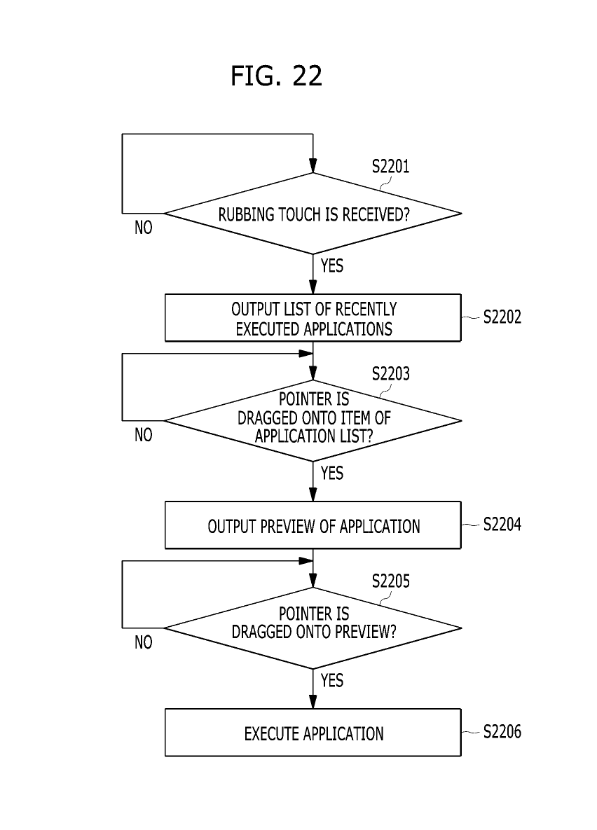

FIG. 22 is a flowchart for a method of operating a mobile terminal according to the present invention. Assume that the mobile terminal is initially laid in an idle state.

Referring to FIG. 22, if a rubbing touch is received via the display unit 151 [S2201], the controller 180 can control a list of recently executed applications to be outputted [S2202].

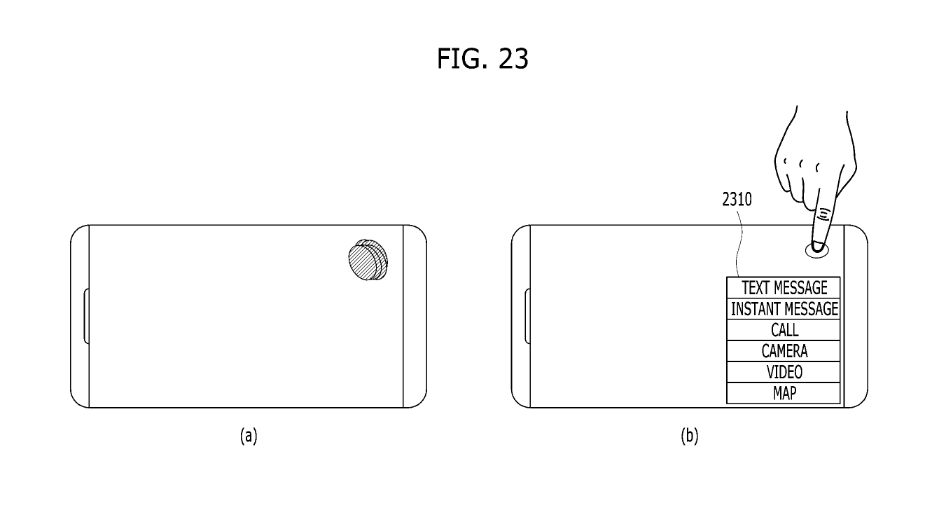

For example, FIG. 23 is a diagram for an example of outputting a list of applications.

As shown in the example of FIG. 23 (a), if a touch input rubbing the display unit 151 is received, as shown in the example of FIG. 23 (b), the controller 180 can control a list of recently executed applications 2310 to be outputted. FIG. 23 (b) shows an example that a text message application, an instant message application, a call application, a camera 121 application, a video application, and a map application are included in the list of recently executed applications. The controller 180 can control a region on which the application list is outputted to maintain on state and control the remaining region to maintain off state among the entire region of the display unit 151.

In this case, the controller 180 may consider a case that a rubbing touch is received when the mobile terminal is laid horizontally (i.e., landscape mode) and a case that a rubbing touch is received when the mobile terminal is laid vertically (i.e., portrait mode). In the former case, the controller 180 outputs a list of applications operated in the landscape mode among the recently executed applications. In the latter case, the controller 180 outputs a list of applications operated in the portrait mode among the recently executed applications. In this case, the controller 180 can determine whether the mobile terminal is laid in horizontally or vertically based on a signal sensed by the sensing unit 140.

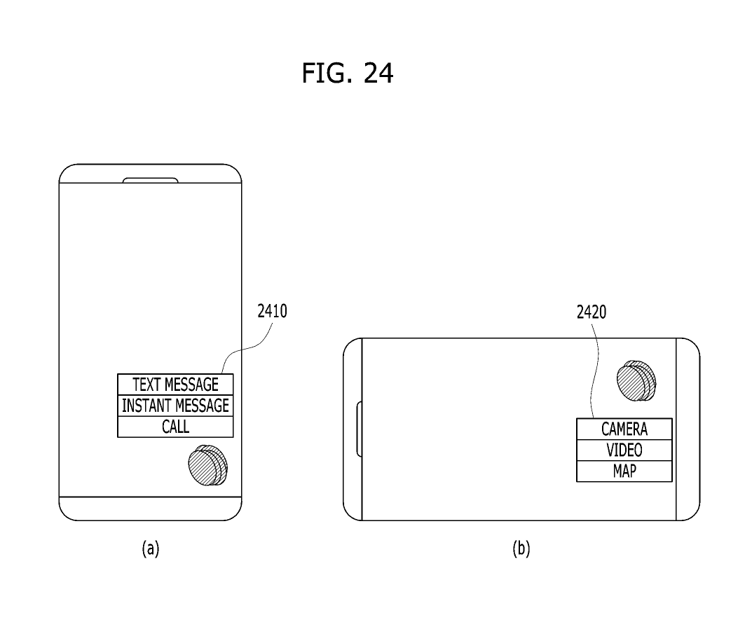

For example, FIG. 24 is a diagram for an example of outputting a list of recently executed applications in a portrait mode and a landscape mode.

If a touch input rubbing the display unit 151 is received in a state that the mobile terminal is laid vertically (i.e., portrait mode), among the recently executed applications, the controller 180 can control a list 2410 of applications executed in the portrait mode to be outputted. FIG. 24 (a) shows an example that a text message application, an instant message application, and a call application are outputted as the list of recently executed applications.

If a touch input rubbing the display unit 151 is received in a state that the mobile terminal is laid horizontally (i.e., landscape mode), among the recently executed applications, the controller 180 can control a list 2420 of applications executed in the landscape mode to be outputted. FIG. 24 (b) shows an example that a camera 121 application, a video application, and a map application are outputted as the list of recently executed applications.

If a pointer is dragged onto an item among the list of applications [S2203], the controller 180 can control a preview of an application corresponding to the selected item to be outputted [S2204]. In this case, the preview may correspond to a screen which is expected to be outputted when the application corresponding to the selected item is executed. The preview may correspond to a screen outputted at the time of terminating an application.

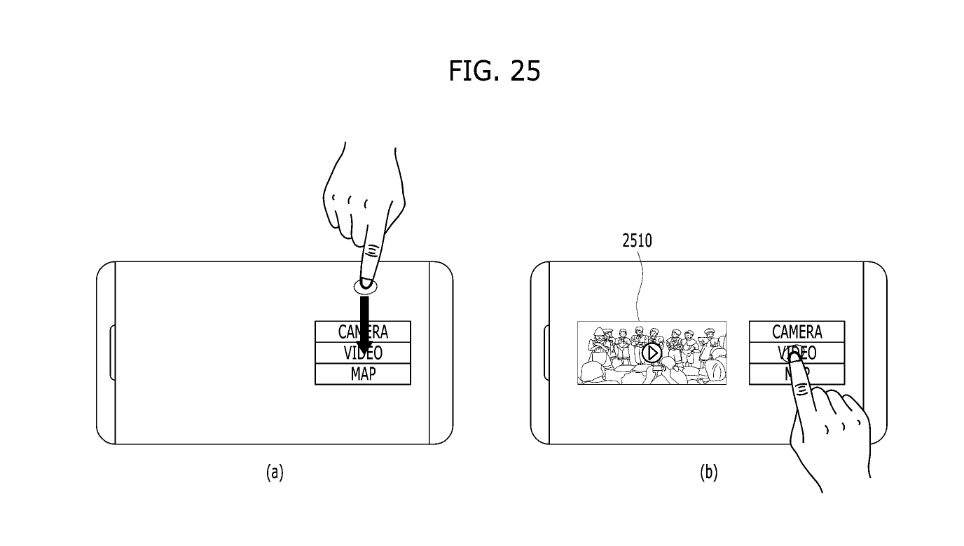

For example, FIG. 25 is a diagram for an example of outputting a preview.

If a pointer touching the display unit 151 is dragged onto an application item among a list of applications, the controller 180 can output a preview of an application corresponding to the selected application item. For example, as shown in the example of FIG. 25 (a), if the pointer is dragged onto a video application, as shown in the example of FIG. 25 (b), the controller 180 can control a preview 2510 of the video application to be outputted.

In this case, the preview of the video application may correspond to a screen which is outputted at the time of terminating the execution of the video application.

In the examples shown in FIGS. 23 to 25, if a touch of the pointer is released from the display unit, the controller 180 stops outputting a list of applications or a preview of an application and can configure the mobile terminal to be in an idle state. In particular, the controller 180 can control the mobile terminal to maintain the normal state only when the pointer touches the display unit 151.

Meanwhile, if the pointer is dragged to the preview or a touch of the pointer, which is dragged to the preview, is released from the display unit 151 [S2205], the controller 180 can control a corresponding application to be executed [S2206].

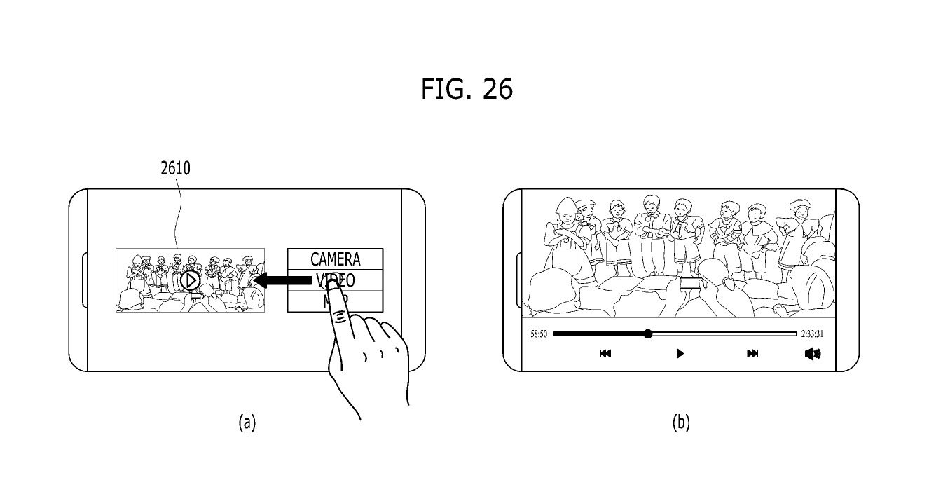

For example, FIG. 26 is a diagram for an example of executing an application.

If an item is selected from a list of applications, as mentioned earlier in FIG. 26 (a), a preview of the selected item can be outputted. FIG. 26 (a) shows an example that a preview 2610 of a video application is outputted.

In this case, if a pointer is dragged into the preview of the video application from the item indicating the video application, the controller 180 can control the video application to be executed. FIG. 26 (b) shows an example that a playback screen for playing a multimedia file, which is played at the time of terminating the video application, is outputted according to the execution of the video application.

<Outputting Quick Setting Menu>

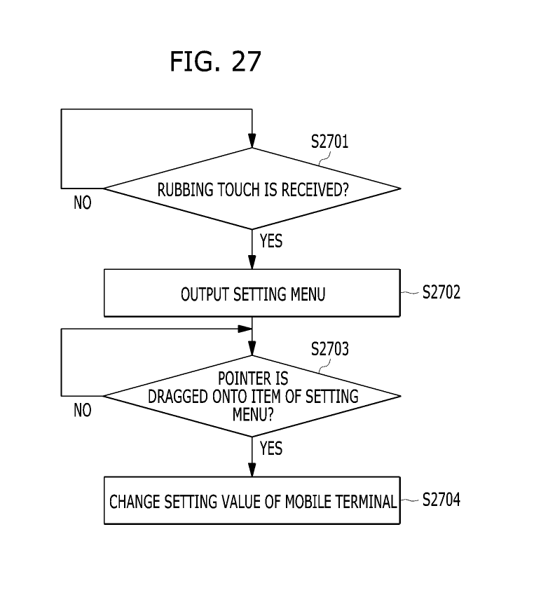

FIG. 27 is a flowchart for a method of operating a mobile terminal according to the present invention. Assume that the mobile terminal is initially laid in an idle state.

Referring to FIG. 27, if a rubbing touch is received via the display unit 151 [S2701], the controller 180 switches the mobile terminal into a normal state and can control a setting menu for controlling a setting of the mobile terminal via the display unit 151 to be outputted [S2702]. The setting menu can include a button for turning on/off various communication modules (e.g., Wi-Fi, Bluetooth, NFC, etc.) mounted on the mobile terminal, a button for turning on/off airplane mode, a button for turning on/off a power saving mode, a button for controlling a vibration mode or a sound mode, and the like.

If a pointer is dragged onto a button of the setting menu or prescribed time elapses after the pointer is dragged onto a button [S2703], the controller 180 can control a setting value corresponding to the selected button [S2704].

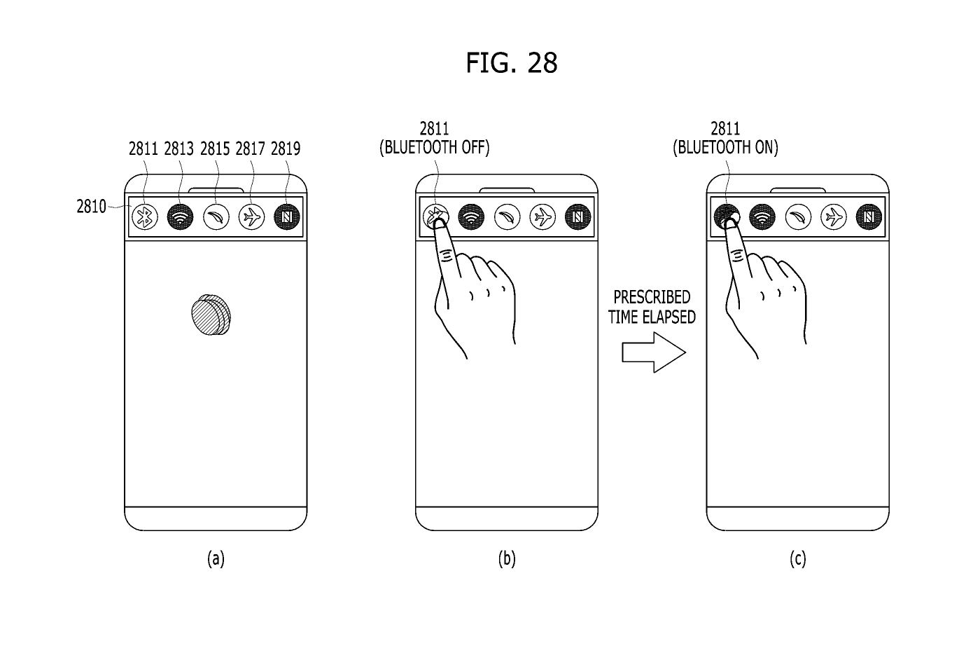

For example, FIG. 28 is a diagram for an example of outputting a setting menu.

If a touch input rubbing the display unit 151 is received, as shown in the example of FIG. 28 (a), the controller 180 can control a setting menu 2810 for controlling a setting value of the mobile terminal to be outputted. FIG. 28 (a) shows an example that the setting menu 2810 includes a button 2811 for controlling on/off of a Bluetooth module, a button 2813 for controlling on/off of a Wi-Fi module, a button 2815 for controlling on/off of a power saving mode, a button 2817 for controlling on/off of an airplane mode, and a button 2819 for controlling on/off of an NFC module. In this case, among the entire region of the display unit 151, the controller 180 can control a region on which the setting menu 2810 is outputted to maintain on state and control the remaining region to maintain off state.

If prescribed time elapses after the pointer is dragged onto a button, the controller 180 can control a setting value corresponding to the selected button to be changed.

For example, as shown in the example of FIG. 28 (b), if the pointer is dragged onto the button 2811 for controlling on/off of the Bluetooth module and a touch touched on the button for controlling on/off of the Bluetooth module is maintained for more than prescribed time, as shown in the example of FIG. 28 (c), the controller 180 can control a setting value for the Bluetooth module to be changed. FIGS. 28 (b) and (c) show an example that the Bluetooth module is changed to on state from off state.

In the example shown in FIG. 28, if a touch of the pointer is released from the display unit 151, the controller 180 can configure the mobile terminal to be in an idle state. In particular, the controller 180 can control the mobile terminal to maintain the normal state only when the pointer touches the display unit 151.

<Outputting Handler for Displaying Graphic Object>

Referring to FIGS. 5, 8, 12, 16, 18, 22, and 27, if a rubbing touch is received, a prescribed graphic object is outputted via the display unit 151 in response to the rubbing touch. As mentioned earlier with reference to the drawings, the graphic object can include prescribed information (e.g., weather information or date information), an application icon for checking an event, a prescribed button (e.g., a camera button, a flash button, etc.), a list of applications, a setting menu, and the like.

Unlike the example, if a rubbing touch is received, the controller 180 may output a handler for outputting a graphic object. If a user input for selecting the handler is received, the controller 180 can control the graphic object to be outputted.

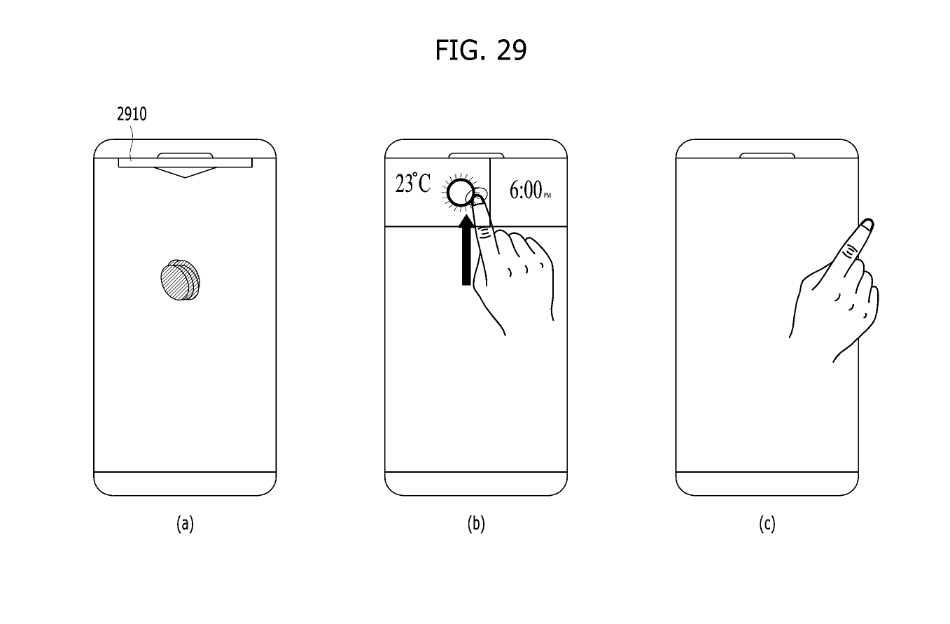

For example, FIG. 29 is a diagram for an example of outputting a handler.

If a touch input rubbing the display unit 151 is received, as shown in an example of FIG. 29 (a), the controller 180 can control a handler 1910 for outputting a graphic object to be outputted. In this case, the handler may correspond to a predetermined image object or a part of a graphic object to be outputted in the future.

Subsequently, if a pointer is dragged towards the handler 2910 or the pointer is dragged onto the handler 2910, as shown in an example of FIG. 29 (b), the controller 180 can control a graphic object to be outputted.

FIG. 29 (b) shows the example that weather and time information 2920 are outputted according to the pointer which is dragged to a position near the handler 2910.

Unlike the example shown in FIG. 29 (b), if the pointer is dragged to the position near the handler, an application icon for checking an event, a flash button, a camera button, a list of applications, a setting menu, and the like can be outputted.

If a touch of the pointer is released from the display unit 151, as shown in an example of FIG. 29 (c), the controller 180 can configure the mobile terminal to be in an idle state.

<Controlling Setting Value>

As mentioned earlier in the introduction part, the mobile terminal according to the present invention can receive a touch input touching the display unit 151 in an idle state. Hence, if a touch input of a predetermined type is received via the display unit 151, the controller 180 can control the mobile terminal to switch to a normal state from the idle state.

For example, if a touch input tapping the display unit 151 two times is received or a touch pattern tapping the display unit 151 is matched with a predetermined password, the controller can control the mobile terminal to deviate from the idle state.

In this case, if a touch input rubbing the display unit 151 is received, the controller 180 can control a button for determining whether or not the idle state of the mobile terminal is terminated by a touch input tapping the display unit 151 to be outputted.

If it is determined as the idle state of the mobile terminal is not terminated by the touch input tapping the display unit 151, although the touch input tapping the display unit 151 is received, the controller 180 can control the mobile terminal to maintain the idle state.

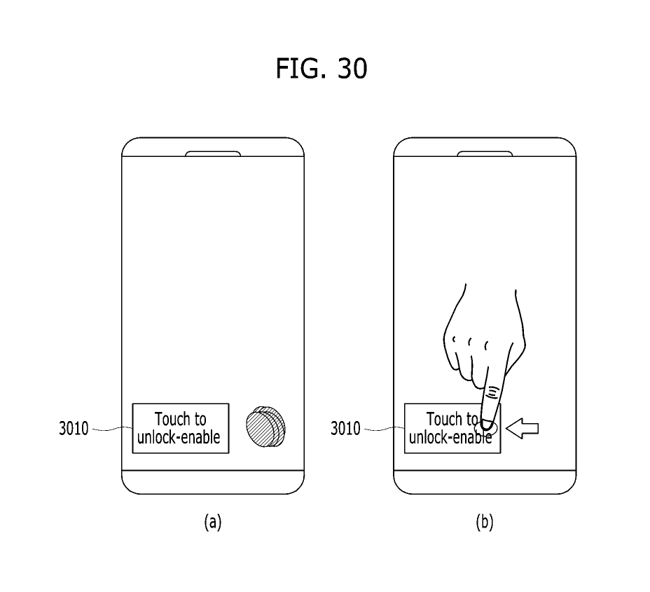

For example, FIG. 30 is a diagram for an example of outputting a button for controlling a setting value of a mobile terminal.

If a touch input rubbing the display unit 151 is received, as shown in an example of FIG. 30 (a), the controller 180 can control a setting button 3010 capable of determining whether or not the idle state of the mobile terminal is terminated by tapping the display unit 151 to be outputted.

Subsequently, if a pointer is dragged to the setting button 3010 or the pointer, which is dragged to the setting button 3010, touches the setting button 3010 for more than prescribed time, the controller 180 can control a setting value to be changed.

For example, FIGS. 30 (a) and (b) shows an example that a setting value is changed to ‘disable’ (i.e., non-permit) from ‘enable’ (i.e., permit).

If the setting value corresponds to ‘enable’, the controller 180 can control the idle state of the mobile terminal to be terminated in response to a tapping input of a predetermined type tapping the display unit 151 (e.g., a touch input tapping the display unit 151 two times or a tapping input of a pattern matched with a predetermined password).

On the contrary, if the setting value corresponds to ‘disable’, although a tapping input of a predetermined type tapping the display unit 151 is received, the controller 180 can control the mobile terminal to maintain the idle state.

<Commonly Applied Item>

According to the aforementioned embodiments, if a touch of a pointer is released from the display unit after the rubbing touch is inputted, the mobile terminal reenters an idle state. Meanwhile, although the touch of the pointer is released from the display unit, the controller 180 can control a graphic object to be continuously outputted for prescribed time. If the pointer retouches the display unit 151 within the prescribed time, the controller can control the graphic object to be continuously outputted. If a touch input touching the display unit 151 is not received within the prescribed time, the controller can control the mobile terminal to enter the idle state.

Moreover, according to the aforementioned embodiments, a rubbing touch is inputted when the mobile terminal is in the idle state. Yet, although a rubbing touch is inputted when the mobile terminal is in a normal state, it may be able to perform the same operation.

In case of using a rubbing touch, a user can conveniently operate the mobile terminal by a hand holding the mobile terminal. In this case, the controller 180 can control a graphic object to be outputted via the display unit only when a touch input rubbing the display unit 151 using a finger of a hand holding the mobile terminal is received. For example, when a user holds the mobile terminal by a right hand, if a touch input rubbing the mobile terminal using a finger (e.g., a thumb of a right hand) of the right hand is received, the controller can control a graphic object to be outputted. Yet, if a touch input rubbing the mobile terminal using a finger (e.g., a thumb of a left hand) of the left hand is received, the controller can omit the output of the graphic object.

In this case, the controller 180 can check a position of a hand holding the mobile terminal bases on a signal sensed by the sensing unit 140 (e.g., grip sensor) and can also determine whether or not a rubbing touch is inputted by a finger of the hand holding the display unit 151 based on a moving trajectory of a pointer rubbing the display unit 151.

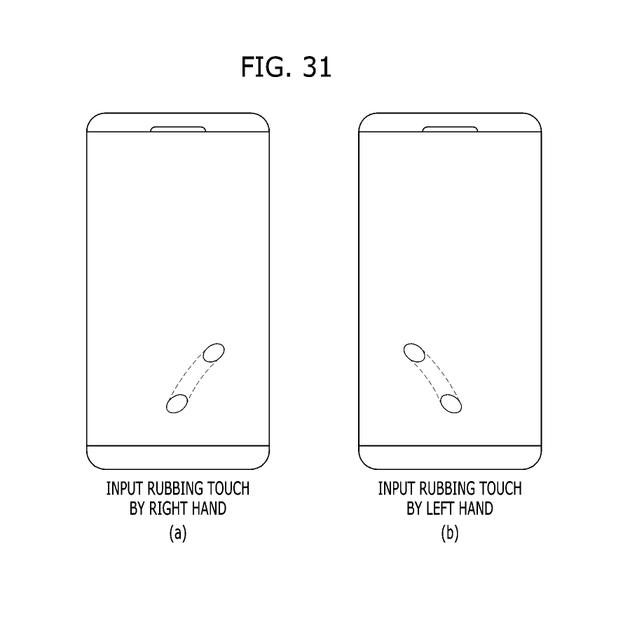

For example, FIG. 31 is a diagram for explaining an example of determining a position of a finger according to a moving trajectory of a pointer. Assume that a thumb rubs the display unit 151. In this case, as shown in an example of FIG. 31 (a), if a moving trajectory of a pointer is inclined in a clockwise direction, the controller 180 can determine it as a rubbing touch is inputted by a finger of a right hand. On the contrary, as shown in an example of FIG. 31 (b), if a moving trajectory of a pointer is inclined in an anticlockwise direction, the controller 180 can determine it as a rubbing touch is inputted by a finger of a left hand.

According to the aforementioned embodiments, it is explained as a graphic object is outputted via the display unit 151 in response to a rubbing touch. Yet, a graphic object can also be outputted in response to a touch input of a form different from the rubbing touch. For example, a graphic object can be outputted on the display unit 151 based on a touch input tapping the display unit 151 for more than a prescribed count, a drag input following a prescribed trajectory, and the like.

A graphic object can be outputted on the display unit 151 not only by a touch input but also by a gesture input using a mobile terminal or a push input pushing a button.

According to the aforementioned embodiments, such a graphic object as a button is outputted via the display unit 151. Although the button has a closed outline such as a circle or a box in general, it is not mandatory. For example, as shown in the example of FIG. 23, each of items constructing a list can be regarded as a button as well. Moreover, a text not having a closed outline can be used as a button as well. In particular, a button described in the present invention may correspond to a common name of an object selected (touched) by a user to perform a specific action. In particular, the aforementioned icon can also be regarded as a sort of a button capable of being used by a user.

According to a part of the aforementioned embodiments, for clarity, it is explained as such a graphic object as an icon is outputted via the display unit 151. Yet, the icon can be replaced with a graphic object (e.g., text) of a different form capable of being selected by a user.

As mentioned earlier in the introduction part, the aforementioned embodiments can be applied to a single mobile terminal. For example, the controller 180 can divide the display unit 151 into a plurality of virtual regions and may be then able to control a graphic object to be outputted according to a region on which a rubbing touch is received.

For example, if a rubbing touch is inputted on a first region of the display unit 151, as mentioned earlier with reference to FIG. 5, the controller can control prescribed information to be outputted. If a rubbing touch is inputted on a second region of the display unit 151, as mentioned earlier with reference to FIG. 8, the controller can control a play button for playing a multimedia file to be outputted.

As a different example, the controller 180 can control a plurality of graphic objects to be outputted at the same time in response to a rubbing touch.

For example, if a rubbing touch is inputted, the controller 180 can output the prescribed information mentioned earlier in FIG. 5 and the play button mentioned earlier in FIG. 8 at the same time.

According to one embodiment of the present invention, the aforementioned method (operation flowchart) can be implemented with a code readable by a processor in a program (or application) or a recording media in which the program is recorded. The examples of the recording media readable by the processor may include a ROM, a RAM, a magnetic tape, a floppy disc, an optical data storing device and the like. And, implementing in a form of a carrier wave such as a transmission via the internet and the like is also included.

The aforementioned mobile terminal 100 is not restricted by the configuration and the method of the aforementioned embodiments. In order to make various variations from the embodiments, all or a part of the embodiments can be selectively combined.

### INDUSTRIAL APPLICABILITY

The present invention can be applied to various types of electronic device equipped with a display unit that functions as an input device receiving a touch input and an output device outputting information.

What is claimed is:

1. A mobile terminal, comprising:
a sensing unit configured to sense a tilt of the mobile terminal;
a display unit configured to output information; and
if a touch input is received via the display unit, a controller configured to control a list of recently executed applications to be outputted in response to the touch input, if the touch input is received in a state that the mobile terminal is laid horizontally, the controller configured to control a first application list, which is executed in a landscape mode, to be outputted, if the touch input is received in a state that the mobile terminal is laid vertically, the controller configured to control a second application list, which is executed in a landscape mode, to be outputted.

2. The mobile terminal of claim 1, wherein if an item is selected from the first application list or the second application list, the controller is configured to control a preview of an application corresponding to the selected item to be outputted.

3. The mobile terminal of claim 2, wherein if the preview is selected, the controller is configured to execute the application.

4. The mobile terminal of claim 1, wherein if the touch input is received when the display unit is turned off, the controller is configured to control the first application list or the second application list to be outputted while turning on the display unit.

5. The mobile terminal of claim 4, wherein if a touch of a pointer, which has inputted the touch input, is released from the display unit, the controller is configured to control the display unit to be in an off state.

6. The mobile terminal of claim 4, wherein if a touch of a pointer, which has inputted the touch input, is released from the display unit, the controller is configured to control the display unit to be in an off state after prescribed time elapsed.

7. The mobile terminal of claim 6, wherein if the pointer retouches the display unit before the prescribed time elapsed, the controller is configured to control the display unit to maintain the off state without being turned off.

8. The mobile terminal of claim 1, further comprising a camera,
wherein the controller is configured to control a camera button for activating the camera to be outputted in response to the touch input.

9. The mobile terminal of claim 8, wherein if the camera button is selected, the controller is configured to control a preview image inputted via the camera and a shutter button for capturing a picture to be outputted.

10. The mobile terminal of claim 9, wherein if the shutter button is selected, the controller is configured to control a captured picture to be outputted via the display unit for prescribed time.

11. The mobile terminal of claim 9, wherein if the prescribed time elapses, the controller is configured to stop outputting the captured picture and control the preview image to be outputted again and wherein if the captured picture is selected before the prescribed time elapsed, the controller is configured to continuously output the captured picture although the prescribed time elapsed.

12. The mobile terminal of claim 10, wherein the controller is configured to control the captured picture to be displayed while a touch touched on the shutter button is maintained and wherein if the touch touched on the shutter button is released, the controller is configured to stop outputting the captured picture and control the preview image to be outputted again.

13. The mobile terminal of claim 1, wherein the controller is configured to control a play button for playing a multimedia file to be outputted in response to the touch input.

14. The mobile terminal of claim 13, wherein the controller is configured to control the multimedia file to be played only when the play button is touched.

15. The mobile terminal of claim 13, wherein the controller is configured to control an object list for checking an event occurred in the mobile terminal to be outputted in response to the touch input.

16. The mobile terminal of claim 15, wherein if an item is selected from the object list, the controller is configured to control detail information of an event corresponding to the selected item to be outputted.

17. The mobile terminal of claim 1, wherein if a pointer moves back and forth on the display unit more than a prescribed count and a maximum moving distance of the pointer is equal to or greater than a predetermined reference value, the controller is configured to determine it as the touch input is inputted.

18. The mobile terminal of claim 1, wherein if a pointer repeats touch and release on a second region surrounding a first region while touching the first region of the display unit, the controller is configured to determine it as the touch input is inputted.

19. The mobile terminal of claim 18, wherein if a third region surrounding the second region is not touched or a count of touching the third region is equal to or less than a predetermined reference value, the controller is configured to determine it as the touch input is inputted.

20. A method of controlling a mobile terminal, comprising the steps of:
receiving a touch input rubbing a display unit; and
outputting a list of recently executed applications in response to the touch input,
wherein if the touch input is received in a state that the mobile terminal is laid horizontally, a first application list, which is executed in a landscape mode, is outputted and wherein if the touch input is received in a state that the mobile terminal is laid vertically, a second application list, which is executed in a landscape mode, is outputted.
